(19) United States
(12) Patent Application Publication
(10) Pub. No.: US 2009/0260468 A1
(43) Pub. Date: Oct. 22, 2009

(54) STEERING DEVICE AND MOVEMENT CONVERTING DEVICE USED THEREFOR

(75) Inventor: Yuji Tachikake, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: THK CO., LTD., Tokyo (JP)

(21) Appl. No.: 12/065,375

(22) PCT Filed: Aug. 31, 2006
(86) PCT No.: PCT/JP2006/317179

§ 371 Date: Jan. 8, 2009

(30) Foreign Application Priority Data
Aug. 31, 2005 (JP) PCT/JP2005/015946

(51) Int. Cl. F16H 25/22

(52) U.S. Cl. 74/424.82

(57) ABSTRACT

Provided is a novel steering device which can be formed to be compact, which is easily applicable to a vehicle with a small engine room such as a front-engine/front-drive car, and which is of neither the ball nut type nor the rack and pinion type. The steering device operates steerable wheels by converting rotation of a steering shaft to axial movement of a relay rod, the steering device including: a gear casing through which the relay rod is passed; a spiral ball rolling groove provided in the relay rod within the gear casing so as to exhibit a lead of a magnitude of 1 or more; a nut member threadedly engaged with the ball rolling groove of the relay rod through an intermediation of a large number of balls and supported rotatably with respect to the gear casing; an input shaft to which rotation of the steering shaft is transmitted and which is in an intersecting or offset relationship with the relay rod; and a first transmission gear for transmitting rotation of the input shaft to the nut member.

### TECHNICAL FIELD

The present invention relates to a steering device for operating steerable wheels in correspondence with rotation of a steering shaft, in particular, a steering device that can be easily developed into an electric power steering device.

### BACKGROUND ART

Conventionally, as steering devices for operating vehicle steerable wheels, there have been known one called a ball nut type and one called a rack and pinion type.

In the former, that is, the ball nut type, rotational movement of a steering shaft imparted by the driver is converted to rocking movement of a pitman arm, and a relay rod connected to the forward end of this pitman arm is moved to the right and left in the axial direction, whereby the direction of the steerable wheels is changed according to the rotating amount of the steering shaft. The ball nut type steering device is so called because a ball nut is used in the process of converting rotational movement of the steering shaft to rocking movement of the pitman arm (JP 05-16826

In the latter, that is, the rack and pinion type steering device, instead of moving the relay rod to the right and left by using the pitman arm, a rack gear is formed on the relay rod, and a pinion gear in mesh with this rack gear is provided at the forward end of the steering shaft; rotational movement of the steering shaft is directly converted to axial movement of the relay rod, thereby changing the direction of the steerable wheels by the relay rod (JP 2005-199776 A). As compared with the ball nut type device described above, this type of steering device is more space saving, and is widely used for small automobiles with small engine room, front-engine/front-drive cars (FF), etc.

As a means for relieving the operating force required when such a steering device is operated by the driver, a power steering device prevails. The power steering device is of types: a hydraulic type and an electric type. Conventionally, the hydraulic type power steering device has been mainstream, and the electric type power steering device has only been used in certain kinds of automobiles such as light cars. However, in the hydraulic type power steering device, a hydraulic pump is driven by using a part of the engine power, so the fuel efficiency of the engine tends to deteriorate; in recent years, in consideration of the environment, the adoption of electric power steering devices is on the increase.

An electric power steering device is used in combination with a rack and pinion type steering device; as typical examples of such a combination, a so-called pinion assist type and a so-called rack assist type are known. In the former, i.e., the pinion assist type, rotation of a pinion gear itself is assisted by an electric motor, whereas, in the latter, i.e., the rack assist type, the rotational torque of an electric motor is converted to an axial force in a direction parallel to a relay rod by using a ball screw, and axial movement of the relay rod is assisted (JP 2005-212710 A, JP 2005-212654 A, etc.).

Patent Document 1: JP 05-16826 A

Patent Document 2: JP 2005-199776 A

Patent Document 3: JP 2005-212710 A

Patent Document 4: JP 2005-212654 A

### DISCLOSURE OF THE INVENTION

### Problems to be Solved by the Invention

However, in the rack and pinion type steering device, a rack gear is formed on apart of the relay rod, so, when the strength of the rack gear is taken into consideration, the shaft diameter of the relay rod must be of a certain magnitude or more; thus, in view of the proper mechanical strength of the relay rod as required for the operation of the steerable wheels, the shaft diameter of the relay rod with the rack gear formed thereon is inevitably excessively large. Further, due to the formation of the rack gear, the relay rod cannot be formed as a hollow shaft. Thus, it is rather difficult to achieve a reduction in weight of the relay rod.

Further, in the rack and pinion type steering device, the surface resistance of the steerable wheels is directly exerted on the rack shaft, so a large force is required to move the rack shaft in the axial direction; the pinion gear will run idle unless the pinion gear is pressed against the rack gear. Thus, in the rack and pinion type steering device, a rack guide urged by a retainer spring is provided behind the rack gear of the rack shaft, and this rack guide presses the rack gear against the pinion gear with a fixed pressure.

However, when the rack guide is thus held in press contact with the rack shaft, the movement of the rack shaft becomes rather heavy due to the frictional force between the two components, and smooth movement of the rack shaft is hindered. Also in the case in which an electric power steering device is formed, a large resistance is offered to the axial movement of the rack shaft, so it is necessary for the electric motor to generate a large rotational torque, resulting in an increase in the size of the electric motor and in an increase in cost. Further, since the rack guide is required, the steering gear box accommodating the rack gear and the pinion gear becomes itself rather large.

Further, in the case of the conventional rack assist type electric power steering device, it is necessary to form on the relay rod both the rack gear and a screw portion to be threadedly engaged with a ball nut, so the machining of the relay rod takes a lot of time and effort and cost.

### Means for Solving the Problems

The present invention has been made in view of the above problems in the prior art. It is an object of the present invention to provide a novel steering device which can be formed to be compact, which is easily applicable to a vehicle with a small engine room such as a front-engine/front-drive car, and which is of neither the ball nut type nor the rack and pinion type.

Another object of the present invention is to provide a steering device which can be easily developed into an electric power steering device and which helps to achieve a reduction in production cost through a reduction in size of the electric motor.

That is, the present invention relates to a steering device for operating steerable wheels by converting rotation of a steering shaft to axial movement of a relay rod, the steering device including: a gear casing through which the relay rod is passed; a spiral ball rolling groove provided in the relay rod within the gear casing so as to exhibit a lead of a magnitude of 1 or more; a nut member threadedly engaged with the ball rolling groove of the relay rod through an intermediation of a large number of balls and supported rotatably with respect to the gear casing; an input shaft to which rotation of the steering shaft is transmitted and which is in an intersecting or offset relationship with the relay rod; and a first transmission gear for transmitting rotation of the input shaft to the nut member.

In the steering device of the present invention, constructed as described above, when the steering shaft is rotated, the rotation is transmitted to the input shaft, and further, to the nut member via the first transmission gear. The nut member is threadedly engaged with the ball rolling groove of the relay rod, so, when the nut member rotates, the relay rod moves axially within the gear casing, and the steerable wheels are operated according to the moving amount. That is, in the present invention, by using the first transmission gear and the ball nut, transmission and conversion of movement is effected between the steering shaft and the relay rod in an intersecting or offset relationship with each other, and rotational movement of the steering shaft is converted to axial reciprocating movement of the relay rod, whereby the steerable wheels are operated.

In the present invention, the ball rolling groove is formed in the relay rod; as compared with the case in which the rack gear is formed, the relay rod is capable of maintaining a sufficient level of strength if its shaft diameter is reduced, so a reduction in size and weight of the relay rod is easier to achieve. Further, if the ball rolling groove is formed therein, the relay rod itself can be formed as a hollow shaft, which also helps to achieve a reduction in weight of the relay rod and, by extension, to achieve a reduction in weight of the steering device as a whole. Further, by forming the relay rod as a hollow shaft, it is also possible to accommodate various kinds of electrical wiring by utilizing the inner space of the relay rod. By accommodating the wiring in the inner space of the relay rod, which is superior in strength, it is possible to prevent the wiring from being cut off inadvertently; for example, the wiring for the various sensors provided in the vicinity of the steerable wheels can be routed safely.

Further, in the steering device of the present invention, the relay rod can be moved in the axial direction solely by rotating the nut member, which is threadedly engaged with the relay rod through the intermediation of a number of balls, and no large frictional resistance is exerted between the nut member and the relay rod. Thus, the relay rod can be smoothly moved in the axial direction, and, as compared with the conventional rack and pinion type steering device, it is possible to operate the steerable wheels more lightly. Further, there is no need to provide a rack guide as in the case of the conventional rack and pinion type steering device, which also helps to achieve a reduction in size of the steering device, and the steering device is also applicable to vehicles with small engine room like front-engine/front-drive cars and light cars.

Further, even when the steerable wheels are rocked in the axial direction by surface resistance, the efficiency with which axial movement of the relay rod is reversely converted to rotational movement of the steering shaft is lower than that in the case of the rack and pinion type device, so the so-called kickback, in which the behavior of the steerable wheels is transmitted to the steering wheel, is appropriately attenuated, thus making it possible to achieve an improvement in terms of safety in steering.

Here, a lead L of the spiral ball rolling groove formed in the relay rod is a value obtained by dividing an axial pitch P of the ball rolling groove of the relay rod by a shaft diameter d of the relay rod, that is, the ratio of the magnitude of the pitch P of the ball rolling groove with respect to the shaft diameter d of the relay rod. When L≧1, it means that, when the nut member threadedly engaged with the relay rod makes one rotation, the relay rod advances by a distance d or more in the axial direction.

In the present invention, the reason for setting the lead L of the ball rolling groove to the range of L≧1 is to prevent the axial moving amount of the relay rod with respect to the rotation of the steering shaft from being minimized. That is, in a ball screw, which is made up of a combination of a screw shaft and a ball nut threadedly engaged therewith, when converting rotational movement of the ball nut to linear movement of the screw shaft, the requisite torque for the rotation of the ball nut is reduced as the value of the lead L is reduced. However, the distance by which the screw shaft moves in the axial direction with one rotation of the ball nut is also reduced. Thus, when the lead L of the ball rolling groove is too small, the requisite rotating amount of the steering shaft for operating the steerable wheels increases, resulting in a steering device of rather poor operability.

When the lead L of the ball rolling groove is in the range: L≧1, the axial movement of the relay rod with respect to the rotation of the steering shaft occurs to a marked degree, and the driver can sense the reaction of the steerable wheels in response to the steering operation. Further, since the rotating amount of the nut member with respect to the movement of the relay rod is reduced, noise is not easily allowed to be generated, which is advantageous. Further, in the steering device of the present invention, by appropriately selecting the speed increasing ratio of the first transmission gear for transmitting the rotation of the input shaft, which is operationally connected to the steering shaft, to the nut member, it is possible to adjust the moving amount in the axial direction of the relay rod with respect to the rotating amount of the steering shaft; thus, synergistically with the selection of the lead, it is possible to enhance the degree of freedom in design.

Further, by providing an auxiliary motor aiding the rotation of the nut member, the steering device of the present invention can be easily developed into an electric power steering device. That is, between the steering shaft and the input shaft operationally connected therewith, there is provided a torque detection sensor for detecting the magnitude of the transmission torque therebetween, and the auxiliary motor is rotated according to an output signal from this torque detection sensor and transmits the rotational torque generated by the auxiliary motor to the nut member via a second transmission gear. This aids the rotation of the nut member with the rotation of the steering shaft, facilitating the operation of the steerable wheels.

In particular, according to the steering device of the present invention, the frictional resistance generated between the nut member and the relay rod is small, so, when developing the steering device into an electric power steering device, the rated output of the auxiliary motor may be smaller as compared with that in the conventional rack and pinion type steering device, making it possible to achieve a reduction in size of the auxiliary motor and a reduction in cost.

Further, the steering device of the present invention can be regarded as a movement transmission device for converting rotational movement of an input shaft to axial linear movement of an output shaft. That is, it is to be understood that, according to the present invention, there is provided a movement transmission device which has an input shaft and an output shaft that are in an intersecting or offset relationship with each other and which converts rotational movement of the input shaft to axial linear movement of the output shaft, the movement transmission device including: a gear casing through which the output shaft is passed; a spiral ball rolling groove provided in the output shaft within the gear casing and exhibiting a lead whose magnitude is 1 or more; a nut member which is threadedly engaged with the ball rolling groove of the output shaft through the intermediation of a large number of balls and which is supported rotatably with respect to the gear casing; and a power transmission gear for transmitting rotation of the input shaft to the nut member, which is in an intersecting or offset relationship with the input shaft.

### BRIEF DESCRIPTION OF THE DRAWINGS

FIG. 1 is a schematic view of a steering device according to a first embodiment of the present invention.

FIG. 2 is a perspective view of a movement converting device accommodated in a gear casing of the steering device of the first embodiment.

FIG. 3 is an exploded perspective view of the movement converting device accommodated in the gear casing of the steering device of the first embodiment.

FIG. 4 is a perspective view of an example of a nut member that can be used in a steering device according to the present invention.

FIG. 5 is a block diagram illustrating an auxiliary motor control system in a power steering device.

FIG. 6 is a perspective view of a movement converting device according to a second embodiment of the present invention accommodated in the gear casing of a steering device.

FIG. 7 is a schematic view of a reference cylinder angle of torsion of a driven-side screw gear and a driving-side screw gear.

FIG. 8 is a schematic view of an example of how a nut member is elastically supported with respect to a gear casing.

FIG. 9 is a perspective view of another example of a nut member that can be used in a steering device according to the present invention.

FIG. 10 is a longitudinal sectional view, taken in the axial direction, of the nut member shown in FIG. 9.

FIG. 11 is a sectional view taken along the line X-X of FIG. 9.

### DESCRIPTION OF REFERENCE NUMERALS

1 . . . steering wheel, 2 . . . steering shaft, 3 . . . relay rod, 12 . . . ball rolling groove, 13 . . . nut member, 14 . . . stationary outer cylinder, 15 . . . driven gear, 16 . . . input shaft, 17 . . . driving gear, 30 . . . auxiliary motor

### BEST MODES FOR CARRYING OUT THE INVENTION

In the following, the steering device of the present invention will be described in detail with reference to the accompanying drawings.

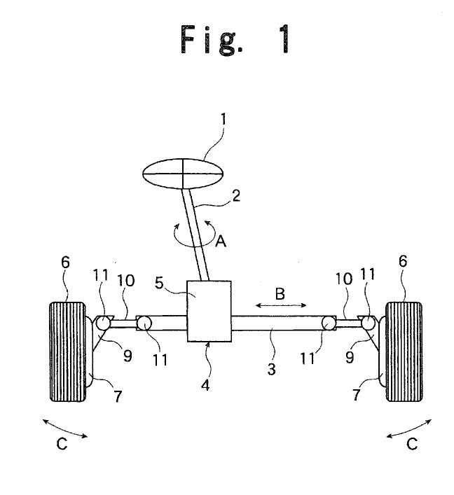

FIG. 1 shows an example of a steering device according to the present invention. This steering device has a steering shaft 2 connected to a steering wheel 1, a relay rod 3 adapted to move in the axial direction upon rotation of the steering shaft 2, and a movement converting device 4 which converts rotation of the steering shaft 2 to axial movement of the relay rod 3, with the relay rod 3 being passed through a gear casing 5 of the movement converting device 4. Hubs 7 supporting right and left steerable wheels 6 are provided with knuckle arms 9, and the ends of the relay rod 3 are respectively connected to the right and left knuckle arms 9 through the intermediation of tie rods 10. The connection between the knuckle arms 9 and the tie rods 10 and the connection between the tie rods 10 and the relay rod 3 are effected via ball joints 11.

When the steering wheel 1 is turned to rotate the steering shaft 2 in one of the directions as indicated by the arrow line A, the relay rod 3 moves in the axial direction (indicated by arrow line B) according to the rotating direction, and the tie rods 10 push and draw the knuckle arms 9, with the result that the right and left steerable wheels 6 swing as indicated by the arrow lines C to be changed in their direction.

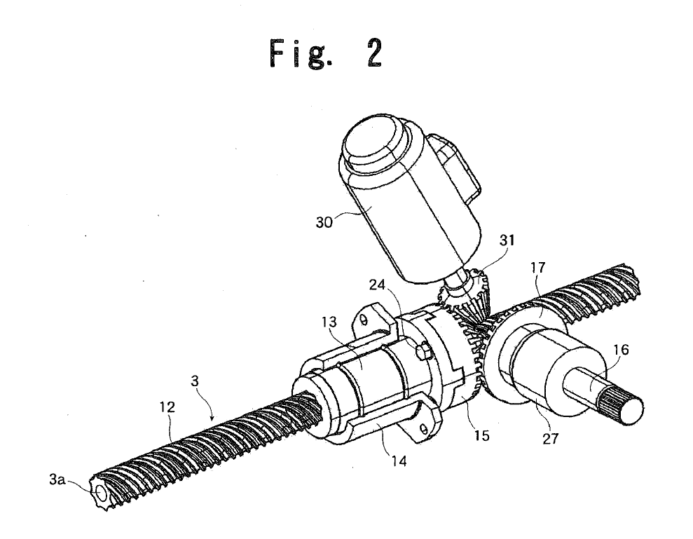

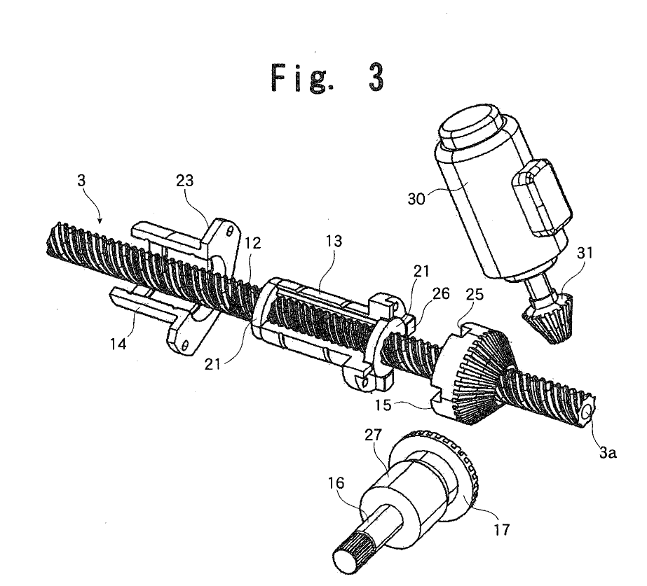

FIGS. 2 and 3 show a first embodiment of the movement converting device 4. FIG. 2 is a perspective view with the gear casing 5 removed, and FIG. 3 is a partially cutaway exploded perspective view of the same. The movement converting device 4 includes the relay rod 3 passed through the gear casing 5, a spiral ball rolling groove 12 formed in the surface of the relay rod 3, a nut member 13 threadedly engaged with the relay rod 3 at the position where the ball rolling groove 12 is formed, a stationary outer cylinder 14 fixed to the casing 5 and rotatably supporting the nut member 13, a driven gear 15 fixed to one axial end of the nut member 13, an input shaft 16 connected to the steering shaft 2 and adapted to rotate at the same speed as the steering shaft 2, and a driving gear 17 provided at the forward end of the input shaft 16 and in mesh with the driven gear 15.

The relay rod 3 is formed as a cylinder with a hollow portion 3a, thus achieving a reduction in deadweight. The ball rolling groove 12 is not formed over the entire length of the relay rod 3 but is only formed in a region thereof.

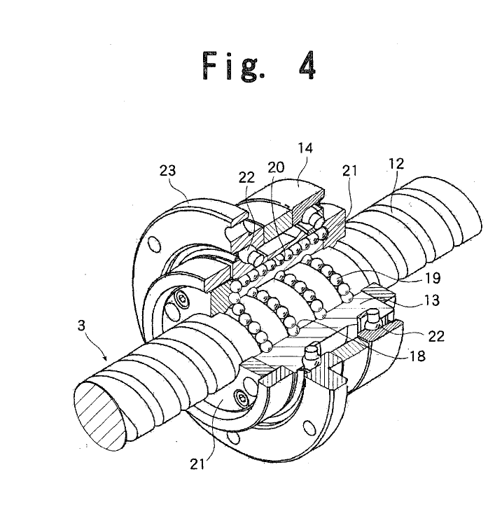

The nut member 13 is threadedly engaged with the ball rolling groove 12 of the relay rod 3 through the intermediation of a large number of balls, forming a ball screw together with the relay rod 3. FIG. 4 is a partially cutaway perspective view of an example of the combination of the nut member 13 and the stationary outer cylinder 14. The nut member 13 is formed as a cylinder with a hollow portion through which the relay rod 3 is passed, and has in the inner peripheral surface thereof a ball rolling grooves 18 opposed to the ball rolling groove 12 of the relay rod 3. When the nut member 13 rotates, balls 19 roll spirally around the relay rod 3 while bearing a load between the ball rolling groove 12 of the relay rod 3 and the ball rolling groove 18 of the nut member 13, and, with that, the relay rod 3 moves in the axial direction. The nut member 13 has a ball return path 20 extending in the axial direction, and pair of end caps 21 are respectively fixed to both axial end surfaces of the nut member 13; the balls 19 that have reached one end of the nut member 13 after rolling through the ball rolling groove 18 are sent into the return path 20 via the end cap 21 fixed to this end portion, and are returned to the initial position in the ball rolling groove 18 via the end cap 21 fixed to the other end portion of the nut member 13. That is, an endless circulation path for the balls 19 is formed in the nut member 13; as the nut member 13 rotates, the balls 19 circulate through the endless circulation path, making it possible to continuously move the relay rod 3 in the axial direction thereof.

Further, the above-mentioned stationary outer cylinder 14 is fitted onto the outer peripheral surface of the nut member 13 through the intermediation of a large number of balls 22; the nut member 3, the balls 22, and the stationary outer cylinder 14 are combined to form a double row angular contact bearing. The stationary outer cylinder 14 is equipped with a flange portion 23; by fixing the flange portion 23 to the gear casing 5 by using bolts, the nut member 13 is supported rotatably with respect to the gear casing 5. As a result, when rotation is imparted to the nut member 13, the relay rod 3 moves in the axial direction with respect to the gear casing 5 according to the rotating direction.

On the other hand, the input shaft 16 is connected to the above-mentioned steering shaft 2 through the intermediation of a torsion bar (not shown) , and the same rotation as that of the steering shaft 2 is imparted thereto. The input shaft 16 and the relay rod 3 intersect each other, and transmission of rotation from the input shaft 16 to the nut member 13 is effected via a bevel gear. That is, the driving gear 17 fixed to the forward end of the input shaft 16 and the driven gear 15 fixed to one axial end of the nut member 13 are formed as bevel gears; the driving gear 17 and the driven gear 15 are in mesh with each other, whereby rotation of the steering shaft 2 is transmitted to the nut member 13. In the present invention, the concept of a first transmission gear includes the driving gear and the driven gear. The mounting of the driven gear 15 to the nut member 13 is effected by using a bolt 24; in order to make the connection between the nut member 13 and the driven gear 15 firm, a key groove 25 is formed in the rear surface of the driven gear 15, and a key 26 provided on the nut member 13 is fit-engaged with the key groove 25. Further, in order to eliminate backlash between the driving gear 17 and the driven gear 15 and to bring them reliably into mesh with each other, the driving gear 17 is urged toward the driven gear 15 by a retainer spring (not shown) accommodated in a case 27.

In the example of the movement converting device 4 shown in FIG. 2, the relay rod 3 and the input shaft 16 intersect each other, so bevel gears are used as the driving gear 17 and the driven gear 15; when the relay rod and the input shaft 16 are so-called skew shafts in an offset relationship with each other, it is possible to use a high-point gear and a worm gear. In the case where the bevel gear and the high-point gear are used, the respective face angles of the gears are appropriately selected, whereby flexible adjustment is possible with respect to the arrangement of the steering shaft 2 relative to the relay rod 3.

The speed increase ratio when transmitting rotation from the driving gear 17 at the forward end of the input shaft 16 to the driven gear 15 fixed to the nut member is set to be approximately 1.5, with the nut member 13 rotating faster than the steering shaft 2. The lead L of the ball rolling groove 12 formed in the relay rod 3 is set to the range: L≧1. Thus, when the nut member 13 makes one rotation, the relay rod 3 moves in the axial direction by a distance not less than the shaft diameter thereof. The setting of the gear ratio between the driving gear 17 and the driven gear 15 and the setting of the lead L of the ball rolling groove 12 of the relay rod 3 can be appropriately selected according to the requisite axial moving amount of the relay rod 3 per one turn of the steering wheel 1.

On the other hand, this steering device is equipped with an auxiliary motor 30 aiding the rotation of the nut member 13, which means the steering device is formed as an electric power steering device. The auxiliary motor 30 is attached to the gear casing 5. An auxiliary driving gear 31 formed as the bevel gear is provided at the forward end of the auxiliary motor 30 inserted into the gear casing 5, and the auxiliary driving gear 31 is in mesh with the driven gear 15 fixed to the nut member 13. That is, the driven gear 15 is in mesh with both the driving gear 17 and the auxiliary driving gear 31. Thus, when the auxiliary motor 30 is rotated, the nut member 13 rotates, which also causes the relay rod 3 to move in the axial direction. The speed reduction ratio in the transmission of rotation from the auxiliary driving gear to the driven gear is set to be 1 or more.

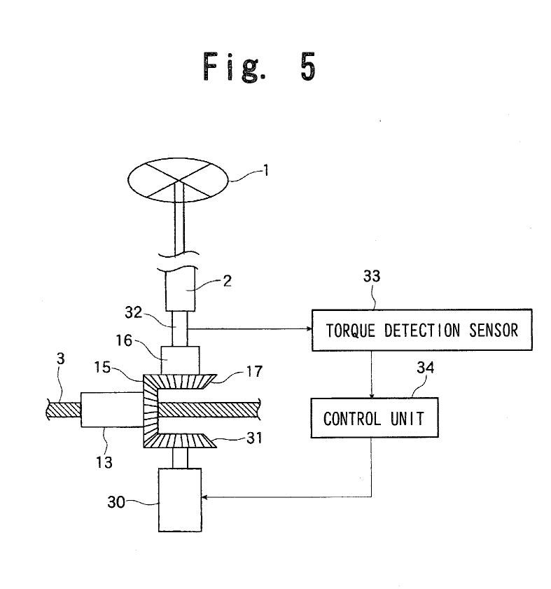

FIG. 5 is a block diagram showing a control system for the auxiliary motor 30. The steering shaft 2 is connected to the input shaft 16 through the intermediation of a torsion bar 32. When the driver turns the steering wheel 1 to rotate the steering shaft 2, the rotational torque of the steering shaft 2 is transmitted to the input shaft 16 through the torsion bar 31. On the other hand, the surface resistance of the steerable wheels 6 acts on the rotation of the nut member 13, so the surface resistance also acts on the input shaft 16 via the driven gear 15 and the driving gear 17. Thus, the larger the surface resistance and the harder the steering wheel 1 is to turn, the larger rotational torque is imparted to the steering shaft 2 by the driver, resulting in generation of a large angle of torsion in the torsion bar 32. Thus, by measuring the torsion of the torsion bar 32 by a torque detection sensor 33, it is possible to ascertain the magnitude of the rotational torque imparted to the steering shaft 2 by the driver, that is, the heaviness of the steering operation.

An output signal from the torque detection sensor 33 is input to a control unit 34 formed by a microcomputer system. The control unit 34 produces a drive control signal for the auxiliary motor 30 based on the output signal of the torque detection sensor 33, and outputs it to the drive portion of the auxiliary motor 30. As a result, the auxiliary motor 30 is drive-controlled such that, the larger the torsion of the torsion bar 32, the larger rotational torque it generates, and the rotational torque is imparted to the nut member 13 via the auxiliary driving gear 31 and the driven gear 15. That is, the heavier the steering operation for the driver, the larger rotational torque the auxiliary motor 30 provides, thus relieving the burden on the driver in the steering operation. While in this example the auxiliary motor 30 is controlled based solely on the rotational torque transmitted between the steering shaft 2 and the input shaft 16, it is also possible to control the auxiliary motor 30 taking into consideration such information as the vehicle speed and the rotation angle of the steering shaft 2.

The auxiliary motor 30 may be provided as needed. When the auxiliary motor 30 is omitted, the device can be simply used as an ordinary steering device. Further, while in the example shown in FIG. 3 the auxiliary driving gear 31 and the driven gear 15 are held in mesh with each other, and the nut member 13 is directly rotated by the auxiliary motor 30, the mounting position for the auxiliary motor 30 is not restricted to the one described above. For example, it is also possible for the auxiliary motor 30 to aid the rotation of the input shaft 16 or the rotation of the steering shaft 2, thus aiding, as a result, the rotation of the nut member 13.

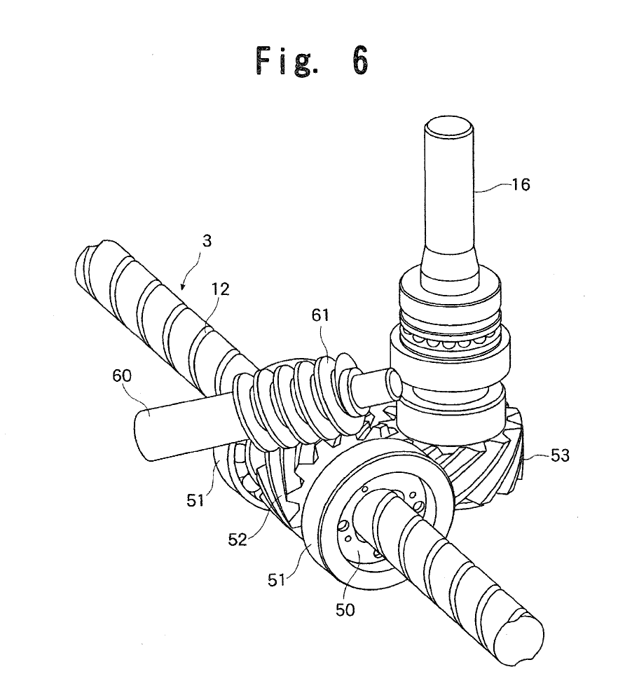

Next, FIG. 6 is a perspective view of a movement converting device according to a second embodiment of the present invention, with the gear casing being removed as in the case of FIG. 2.

In the second embodiment also, the movement converting device includes the relay rod 3 provided so as to extend through the gear casing 5, the spiral ball rolling groove 12 formed in the surface of the relay rod 3, a nut member 50 threadedly engaged with the relay rod 3 at the portion where the ball rolling groove 12 is formed, a stationary outer cylinder 51 fixed to the casing 5 and rotatably supporting the nut member 50, and the input shaft 16 connected to the steering shaft 2 and adapted to rotate at the same speed as the steering shaft 2.

While in the first embodiment shown in FIGS. 2 and 3 the bevel gear serving as the driven gear 15 is fixed to one axial end of the nut member 13, in the second embodiment, a screw gear 52 is formed in the outer peripheral surface of the nut member 50, and this screw gear is used as the driven gear. The driven-side screw gear 52 is provided substantially at the longitudinal center of the nut member 50, and a pair of stationary outer cylinders 51 are attached to the nut member 50 so as to axially sandwich the driven-side screw gear 52. That is, a pair of ball rolling grooves are formed circumferentially in the outer peripheral surface of the nut member 50 so as to axially sandwich the screw gear 52, and the stationary outer cylinders 51 are fit-engaged with the nut member through the intermediation of a large number of balls rolling through those ball rolling grooves. Thus, by fixing the pair of stationary outer cylinders 51 to the gear casing 5, the nut member 50 can be supported rotatably with respect to the gear casing 5.

The above-mentioned driven-side screw gear 52 may be directly formed in the outer peripheral surface of the nut member 50 by machining, or the screw gear 52 may be formed separately by machining and fixed to the outer peripheral surface of the nut member 50.

On the other hand, the input shaft 16 is in an offset relationship with the relay rod 3, and a driving-side screw gear 53 in mesh with the driven-side screw gear 52 is fixed to the forward end of the input shaft 16. As a result, when the input shaft 16 rotates, the rotation is transmitted from the driving-side screw gear 53 to the driven-side screw gear 52, and the nut member 50 rotatably supported with respect to the stationary outer cylinders 51 rotates according to the rotating amount of the input shaft 16.

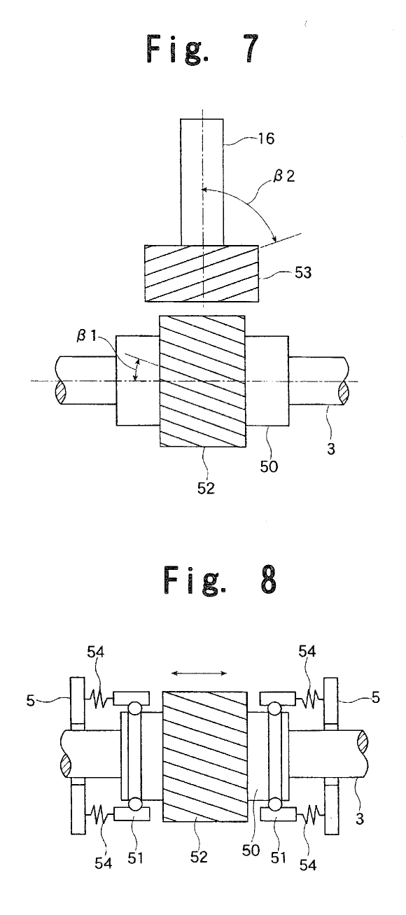

As shown in FIG. 7, assuming that the reference cylinder angle of torsion of the driven-side screw gear 52 is β1, and that the reference cylinder angle of torsion of the driving-side screw gear 53 is β2, the crossing angle of the relay rod 3 and the input shaft 16 can be expressed by a formula β1+β2. Thus, by arbitrarily adjusting the reference cylinder angles of torsion β1 and β2 of the driven-side screw gear 52 and the driving-side screw gear 53, respectively, it is possible to arbitrarily select the crossing angle of the relay rod 3 and the input shaft 16.

In the steering device, when an impact load is exerted to the steerable wheels from the road surface, that force is transmitted as a so-called kickback to the steering wheel 1 via the relay rod 3 and the input shaft 16. When transmitted to the driver to an excessive degree, the kickback adversely affects the operation of the steering wheel 1, so, in the steering device, it is necessary to secure a quick reaction of the steerable wheels 6 when the steering wheel 1 is operated while suppressing the transmission of the kickback.

From this point of view, it is desirable that the setting of the transmission efficiency of the first transmission gear for transmitting the rotation of the input shaft 16 to the nut member 50 be made such that, as compared with the efficiency of transmission in the normal direction from the input shaft 16 to the nut member 50, the efficiency of transmission in the reverse direction from the nut member 50 to the input shaft 16 is low. When the transmission efficiency of the first transmission gear can be thus set, the relay rod 3 reacts quickly to the operation of the steering wheel 1 to provide a satisfactory steering feel, and, at the same time, the kickback transmitted to the steering wheel 1 is attenuated, and the driver can perform steering while feeling the road surface condition to an appropriate degree.

More specifically, by adjusting the reference cylinder angles of torsion β1 and β2 of the driven-side screw gear 52 and the driving-side screw gear 53 forming the first transmission gear, it is possible to realize the above-mentioned transmission efficiency. That is, the reference cylinder angle of torsion β1 of the driven-side screw gear 52 is set smaller than the reference cylinder angle of torsion β2 of the driving-side screw gear 53. Through this setting, as compared with the transmission efficiency of the transmission in the normal direction, in which the rotation of the input shaft 16 is transmitted to the nut member 50, the transmission efficiency of the transmission in the reverse direction, in which the rotation of the nut member 50 is transmitted to the input shaft 16, is low, with the result that transmission of kickback to the input shaft 16 and, by extension, to the steering shaft 2, is prevented as much as possible.

On the other hand, when the transmission of kickback is thus attenuated between the nut member 50 and the input shaft 16, the impact load acting axially on the relay rod 3 due to the kickback is allowed to be exerted as it is in the axial direction of the nut member 50, so there is a fear of damage of the nut member 50 and damage of the ball rolling groove 12 formed in the relay rod 3. Thus, when the transmission efficiency in the reverse direction of the first transmission gear is set small, it is desirable to make the nut member 50 axially displaceable with respect to the gear casing 5 as schematically shown in FIG. 8, and to attach elastic members 54 such as springs to both axial ends of the nut member 50, supporting the nut member 50 elastically in the axial direction. In this construction, if an impact load due to the kickback is exerted in the axial direction of the nut member 50, it can be received through expansion and contraction of the elastic members 54, making it possible to prevent damage of the nut member 50 and damage of the ball rolling groove 12 of the relay rod 3.

Further, in the movement converting device of the second embodiment, an auxiliary motor aiding the rotation of the nut member 50 is fixed to the gear casing 5, thus forming the steering device as an electric power steering device. As shown in FIG. 6, at the forward end of an output shaft 60 of the auxiliary motor, there is provided an auxiliary driving gear 61 in mesh with the driven-side screw gear 52, and the auxiliary driving gear 61 is formed as a worm gear. Thus, when the auxiliary motor 30 is rotated, the nut member 13 rotates, which also causes the relay rod 3 to move in the axial direction. The control system for the auxiliary motor is the same as that of the first embodiment illustrated with reference to FIG. 5.

In the second embodiment, the driving-side screw gear 53 and the auxiliary driving gear 61 are held in mesh with the driven-side screw gear 52 provided on the outer peripheral surface of the nut member 50, and the input from the steering wheel 1 and the input from the auxiliary motor are transmitted directly to the nut member 50, whereby it is possible to form a very compact power steering device.

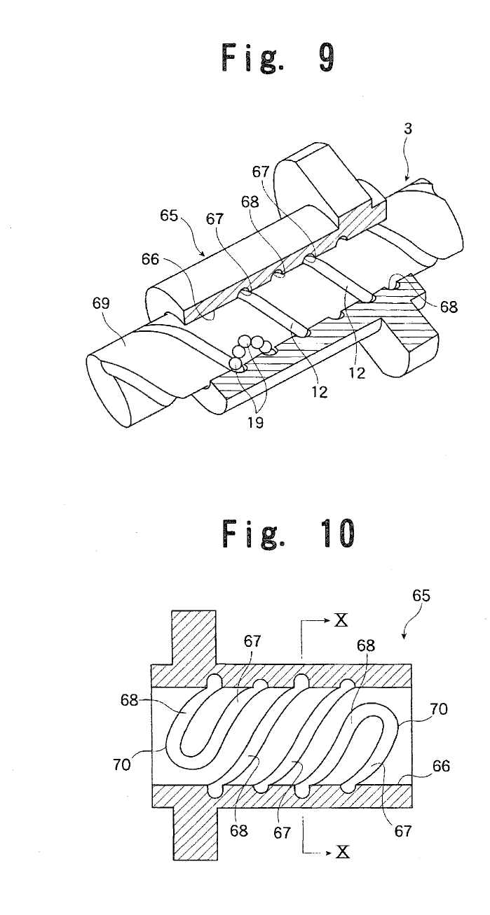

FIGS. 9 through 11 show another example of a nut member that can be used in the present invention.

In the nut member 13 shown in FIG. 4, a pair of end caps 21 are respectively fixed to both axial ends of the nut member 13 to form an endless circulation path for the balls 19. In contrast, in a nut member 65 shown in FIG. 9, cutting or grinding is performed on the inner peripheral surface of the nut member 65, whereby an endless circulation path for the balls 19 is formed without using any other member such as end caps. FIG. 9 does not show all the balls 19 but only a portion of the balls 19 arranged between the relay rod 3 and the nut member 65.

The nut member 65 is substantially formed as a cylinder with a through-hole 66 through which the relay rod 3 is passed. FIG. 9 is a sectional view of the nut member 65 taken in the axial direction. As shown in the figure, a spiral ball rolling groove 67 opposed to the ball rolling groove 12 of the relay rod 3 is formed in the inner peripheral surface of the through-hole 66 of the nut member 65. The sectional configuration of the ball rolling groove 67 as taken in a direction orthogonal to the advancing direction of the balls 19 is the same as the sectional configuration of the ball rolling groove 12 of the relay rod 3. The ball rolling groove 67 and the ball rolling groove 12 of the relay rod 3 are opposed to each other, whereby there is formed between the nut member 65 and the relay rod 3 a spiral load ball path through which the balls 19 revolve around the relay rod 3 while bearing a load. In the example shown in FIGS. 9 through 11, the ball rolling groove 67 of the nut member 65 is formed as a double-start thread, and the corresponding ball rolling groove 12 of the relay rod 3 is also formed a double-start thread.

Further, in the inner peripheral surface of the through-hole 66 of the nut member 65, there is formed a spiral non-load ball groove 68. The non-load ball groove 68 is formed in the inner peripheral surface of the through-hole 66 so as to be deeper than the ball rolling groove 67 and in a groove width slightly larger than the diameter of the balls 19. Thus, the balls 19 bear no load in the non-load ball groove 68 and are placed in a non-load state, rolling freely as they are pushed by the succeeding balls 19.

While the ball rolling groove 67 of the nut member is opposed to the ball rolling groove 12 of the relay rod 3, the non-load ball groove 68 is opposed not to the ball rolling groove 12 of the relay rod 3 but to a crest portion 69 thereof. The balls 19 rolling in the non-load ball groove 68 in a non-load state are in contact with the crest portion 69 of the relay rod 3, whereby the balls 19 are retained within the non-load ball grooves 68. Thus, in the nut member 65, a non-load ball path is formed through cooperation of the non-load ball groove 68 and the crest portion 69 of the relay rod 3.

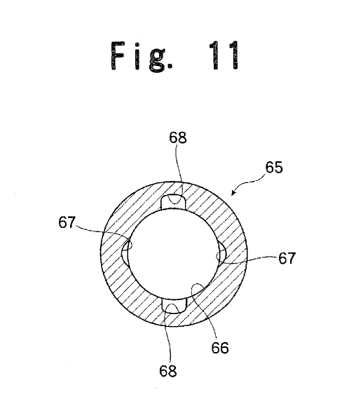

Near both axial ends of the inner peripheral surface of the through-hole 66 of the nut member 65, there are formed substantially U-shaped direction change grooves 70. The direction change grooves 70 establish communication and connection between the ends of the ball rolling groove 67 and the ends of the non-load ball groove 68. In the nut member 65 shown in FIG. 10, the direction change grooves are formed at four positions of the inner peripheral surface of the through-hole 660. In the case in which the ball rolling groove 67 is formed not as a double-start thread but as a single-start thread in the nut member 65, the direction change grooves 70 are formed at two positions of the inner peripheral surface of the through-hole 66.

The direction change grooves 70 are formed continuously with no stepped portion from the ends of the ball rolling groove 67 to the ends of the non-load ball groove 68, with their depth gradually increasing from the ends of the ball rolling groove 67 toward the ends of the non-load ball grooves 68. Since the depth of the ball rolling groove 67 increases gradually, when the balls 19 rolling through the ball rolling groove 67 reach the connecting portions between the ball rolling groove 67 and the direction change grooves 70, the balls 19 are gradually released from the load. The balls 19 released from the load are pushed by the succeeding balls 19, and advance as they are through the ball rolling groove 12 of the relay rod 3. Since the direction change grooves 70 bring the balls 19 to the side of the ball rolling groove 12, the balls 19 climb up the ball rolling groove 12 to the crest portion 69 of the relay rod 3, and are completely accommodated in the direction change grooves 70 of the nut member 65.

Since the direction change grooves 70 include substantially U-shaped paths, the rolling direction of the balls 19 accommodated in the direction change grooves 70 is reversed, and the balls enter the non-load ball path defined by the non-load ball groove 68 of the nut member 65 and the crest portion 69 of the relay rod 3 opposed to each other. In this non-load ball path, the balls 19 are in a non-load state, and advance through the non-load ball path as they are pushed by the succeeding balls 19.

When they reach the connecting portions between the non-load ball groove 68 and the direction change grooves 70, the balls 19 having advanced through the non-load ball path enter the direction change grooves 70 as they are to undergo a change in advancing direction again, and enter the load ball path defined by the ball rolling groove 12 of the relay rod 3 and the ball rolling groove 67 of the nut member 65 opposed to each other. In this process, the balls 19 climb down sidewise the ball rolling groove 12 of the relay rod 3 to enter the load ball path, and undergo transition from the non-load state to the loaded state as the depth of the ball rolling groove 67 gradually decreases at the connecting portions between the direction change grooves 70 and the ball rolling groove 67.

That is, in the nut member 65, the direction change grooves 70 establish communication and connection between the ends of the ball rolling groove 67 of the nut member 65 and the ends of the non-load ball groove 68, whereby an endless circulation path as a closed loop for the balls 19 is provided in the nut member 65. When the nut member 65 rotates relative to the relay rod 3, the balls 19 circulate within the endless circulation path, making it possible to continuously effect the above-mentioned spiral movement.

In the nut member 65 thus constructed, there is no need to form the ball return paths 20 in the axial direction as in the case of the nut member 13 shown in FIG. 4, making it possible to set the thickness of the nut member 65 small. As a result, it is possible to form the nut member 65 as a compact member. Further, the ball rolling groove 67, the non-load ball groove 68, and the direction change grooves 70 can all be formed by directly performing cutting, grinding or the like on the inner peripheral surface of the through-hole 66 of the nut member 65, so, in providing the nut member 65 with the endless circulation path for the balls 19, there is no need to attach a separate component to the nut member 65, thus making it possible to produce the nut member 65 easily and at low cost. In addition, it is possible to form the endless circulation path for the balls 19 without having to fix any separate component to the nut member 65, so even in a case where the device is used in a hostile environment for a long period of time, the device can exhibit high reliability, thus being most suitable for a steering device.

In using the nut member 65, the driven-side bevel gear 15 of the first embodiment may be provided at the axial end surface of the nut member 65, or the driven-side screw gear 52 of the second embodiment may be provided substantially at the center of the outer peripheral surface of the nut member 65.

1. A steering device for operating steerable wheels by converting rotation of a steering shaft to axial movement of a relay rod, the steering device comprising:
a gear casing through which the relay rod is passed;
a spiral ball rolling groove provided in the relay rod within the gear casing so as to exhibit a lead of a magnitude of 1 or more;
a nut member threadedly engaged with the ball rolling groove of the relay rod through an intermediation of a large number of balls and supported rotatably with respect to the gear casing;
an input shaft to which rotation of the steering shaft is transmitted and which is in an intersecting or offset relationship with the relay rod; and
a first transmission gear for transmitting rotation of the input shaft to the nut member.

2. A steering device according to claim 1, wherein the first transmission gear exhibits a lower transmission efficiency in transmission from the nut member to the input shaft than in transmission from the input shaft to the nut member.

3. A steering device according to claim 1, wherein the relay rod and the input shaft are in an offset relationship with each other, and
wherein the first transmission gear includes a driven-side screw gear provided on an outer peripheral surface of the nut member, and a driving-side screw gear fixed to the input shaft and in mesh with the driven-side screw gear.

4. A steering device according to claim 3,
wherein a pair of ball rolling grooves are circumferentially formed in the outer peripheral surface of the nut member with the driven-side screw gear therebetween, and
wherein an outer ring of a rotary bearing is attached to the nut member through the intermediation of a large number of balls rolling through the ball rolling grooves.

5. A steering device according to claim 3, wherein the driven-side screw gear has a reference cylinder angle of torsion set to be smaller than that of the driving-side screw gear.

6. A steering device according to claim 2 or 5, wherein the nut member is elastically supported within the gear casing with respect to a rotation axis direction thereof, and is displaceable in the rotation axis direction when an external force is applied thereto.

7. A steering device according to claim 1, further comprising:
a torque detection sensor for detecting a magnitude of a rotational torque transmitted between the steering shaft and the input shaft; and
an auxiliary motor for aiding rotation of the nut member in response to an output signal from the torque detection sensor.

8. A steering device according to claim 7,
wherein the auxiliary motor is provided such that an output shaft thereof is in an intersecting or offset positional relationship with the nut member, and
wherein there is provided a second transmission gear for transmitting rotation of the auxiliary motor to the nut member, with a speed reduction ratio of the second transmission gear being set to be 1 or more.

9. A steering device according to claim 7,
wherein the first transmission gear includes a driven gear fixed to the nut member and a driving gear fixed to the input shaft and in mesh with the driven gear, and
wherein the second transmission gear includes the driven gear and an auxiliary driving gear fixed to the output shaft of the auxiliary motor and in mesh with the driven gear.

10. A steering device according to claim 9, wherein the driven gear, the driving gear, and the auxiliary driving gear are bevel gears.

11. A steering device according to claim 9, wherein the driven gear, the driving gear, and the auxiliary driving gear are screw gears.

12. A movement converting device having an input shaft and an output shaft in an intersecting or offset relationship with each other and converting rotational movement of the input shaft to axial linear movement of the output shaft, the movement converting device comprising:
a gear casing through which the output shaft is passed;
a spiral ball rolling groove provided in the output shaft within the gear casing and formed so as to exhibit a lead of 1 or more;
a nut member threadedly engaged with the ball rolling groove of the output shaft through an intermediation of a large number of balls and supported rotatably with respect to the gear casing; and
a power transmission gear for transmitting rotation of the input shaft to the nut member, which is in an intersecting or offset relationship with the input shaft.
